(19) United States
(12) Patent Application Publication
(10) Pub. No.: US 2015/0381760 A1
(43) Pub. Date: Dec. 31, 2015

(54) APPARATUS, METHOD AND COMPUTER PROGRAM PRODUCT FOR CONTENT PROVISION

(71) Applicants: Sujeet Shyamsundar MATE, Tampere (FI); Sailesh SATHISH, Bangalore (IN)

(72) Inventors: Sujeet Shyamsundar MATE, Tampere (FI); Sailesh SATHISH, Bangalore (IN)

(73) Assignee: Nokia Corporation, Espoo (FI)

(21) Appl. No.: 14/427,913

(22) PCT Filed: Sep. 14, 2012
(86) PCT No.: PCT/FI2012/050888

§ 371 Date: Mar. 12, 2015

(51) Int. Cl. H04L 29/08; H04L 29/06

(52) U.S. Cl. CPC H04L 67/32; H04L 65/60

(57) ABSTRACT

There is disclosed a method in which a request for transmitting content relating to a collaborated content to a first device is receive. The collaborated content comprises one or more media clips of an event attached with information on a context regarding capturing of the media clips. Further,information on the context of the first device is obtained and a viewpoint of the first device is determined on the basis of the context of the first device and the context regarding capturing of the media clips. An event composition is generated from the one or more media clips of the collaborated content representing the determined viewpoint. There is also disclosed a method in which a request for content relating to the collaborated content to a device is transmitted by the device. Information on the context of the device is transmitted for determination of the viewpoint. The generated event composition is received by the device. There are also disclosed apparatuses and computer programs for implementing the methods.

### TECHNICAL FIELD

The present invention relates to a method at an apparatus for providing content for storing. The invention further relates to an apparatus and a computer program product for providing content for storing. The invention also relates to a method at an apparatus for accessing a collaborated content by an apparatus. The invention further relates to an apparatus and a computer program product for accessing a collaborated content.

### BACKGROUND INFORMATION

This section is intended to provide a background or context to the invention that is recited in the claims. The description herein may include concepts that could be pursued, but are not necessarily ones that have been previously conceived or pursued. Therefore, unless otherwise indicated herein, what is described in this section is not prior art to the description and claims in this application and is not admitted to be prior art by inclusion in this section.

Cameras are often used to capture images and/or video in many events and locations users visit. There may also be some other users nearby capturing images and/or video in the same event but from a different viewpoint. Images, videos and/or other content relating to the event may be uploaded to a server in a network, such as the internet, to be available for downloading by other users and/or by the same user.

The content to be transferred for storage and obtaining at a later stage may be any kind of piece of data which can be represented in an electronic form. For example, the content may be a file containing audio information such as music, speech etc., a video clip, a picture captured by a camera and stored in a digital format, a text file, an email, an event stored in a calendar application, a presentation, etc.

The content transfer may take place e.g. from devices which are in proximity to each other, e.g. in the same geographical location, to a server or to another entity appropriate for storing and retrieving content.

A desire to play back previously recorded content may relate to a group of people who has attended the same event. They or some of them may wish to experience the event by watching the content with each other by using their devices.

### SUMMARY

Some embodiments relate to interactive consumption of crowd sourced user contributed content. Multi-user contributions may be collated into a composition consisting of recorded content by user devices in an event.

According to a first aspect of the invention, there is provided a method comprising:
receiving a request for transmitting content relating to a collaborated content to a first device, the collaborated content comprising one or more media clips of an event attached with information on a context regarding capturing of the media clips;
obtaining information on the context of the first device;
determining a viewpoint of the first device in the collaborated content on the basis of a relationship between the context of the first device and the context regarding capturing of the media clips; and
generating an event composition from the one or more media clips of the collaborated content representing the determined viewpoint.

According to a second aspect of the invention, there is provided an apparatus comprising at least one processor and at least one memory including computer program code, the at least one memory and the computer program code configured to, with the at least one processor, cause the apparatus to perform at least the following:
receive a request for transmitting content relating to a collaborated content to a first device, the collaborated content comprising one or more media clips of an event attached with information on a context regarding capturing of the media clips;
obtain information on the context of the first device;
determine a viewpoint of the first device in the collaborated content on the basis of a relationship between the context of the first device and the context regarding capturing of the media clips; and
generate an event composition from the one or more media clips of the collaborated content representing the determined viewpoint.

According to a third aspect of the invention, there is provided a computer program product including one or more sequences of one or more instructions which, when executed by one or more processors, cause an apparatus to perform at least the following:
receive a request for transmitting content relating to a collaborated content to a first device, the collaborated content comprising one or more media clips of an event attached with information on a context regarding capturing of the media clips;
obtain information on the context of the first device;
determine a viewpoint of the first device in the collaborated content on the basis of a relationship between the context of the first device and the context regarding capturing of the media clips; and
generate an event composition from the one or more media clips of the collaborated content representing the determined viewpoint.

According to a fourth aspect of the invention, there is provided an apparatus comprising:
means for receiving a request for transmitting content relating to a collaborated content to a first device, the collaborated content comprising one or more media clips of an event attached with information on a context regarding capturing of the media clips;
means for obtaining information on the context of the first device;
means for determining a viewpoint of the first device in the collaborated content on the basis of a relationship between the context of the first device and the context regarding capturing of the media clips; and
means for generating an event composition from the one or more media clips of the collaborated content representing the determined viewpoint.

According to a fifth aspect of the invention, there is provided a method at an apparatus, comprising:
transmitting a request for content relating to a collaborated content to a device, the collaborated content comprising one or more media clips of an event attached with information on a context regarding capturing of the media clips;
transmitting information on the context of the device for determination of a viewpoint of the device in the collaborated content on the basis of a relationship between the context of the device and the context regarding capturing of the media clips; and
receiving an event composition generated from the one or more media clips of the collaborated content representing the determined viewpoint.

According to a sixth aspect of the invention, there is provided an apparatus comprising at least one processor and at least one memory including computer program code, the at least one memory and the computer program code configured to, with the at least one processor, cause the apparatus to perform at least the following:
transmit a request for content relating to a collaborated content to a device, the collaborated content comprising one or more media clips of an event attached with information on a context regarding capturing of the media clips;
transmit information on the context of the device for determination of a viewpoint of the device in the collaborated content on the basis of a relationship between the context of the device and the context regarding capturing of the media clips; and
receive an event composition generated from the one or more media clips of the collaborated content representing the determined viewpoint.

According to a seventh aspect of the invention, there is provided a computer program product including one or more sequences of one or more instructions which, when executed by one or more processors, cause an apparatus to perform at least the following:
transmit a request for content relating to a collaborated content to a device, the collaborated content comprising one or more media clips of an event attached with information on a context regarding capturing of the media clips;
transmit information on the context of the device for determination of a viewpoint of the device in the collaborated content on the basis of a relationship between the context of the device and the context regarding capturing of the media clips; and
receive an event composition generated from the one or more media clips of the collaborated content representing the determined viewpoint.

According to an eighth aspect of the invention, there is provided a n apparatus comprising:
means for transmitting a request for content relating to a collaborated content to a device, the collaborated content comprising one or more media clips of an event attached with information on a context regarding capturing of the media clips;
means for transmitting information on the context of the device for determination of a viewpoint of the device in the collaborated content on the basis of a relationship between the context of the device and the context regarding capturing of the media clips; and
means for receiving an event composition generated from the one or more media clips of the collaborated content representing the determined viewpoint.

In some example embodiments, content from multiple user devices in an event and information relating to the context of the devices may be collected to a server, in which the content and context information may be stored. The content may be retrieved from the server by a group of users who may wish to replay the content or parts of it. The group of users may be logically connected or geographically co-located. The term geographically co-located means in this context users within the same, relatively small area. For example, the users may be located within the same park or in the same room. On the other hand, the users may be logically connected although they were not geographically co-located. For example, one of the users could be travelling by bus, another user could be in her/his home, and yet another user could be walking in a park while they wanted to experience together an earlier event once more. Some embodiments provide a solution to that kind of situations. This kind of collaborative content consumption for an event may provide a richer experience to users compared to a single event composition version of an event which may have a shorter viewership tail, since the content may become “stale”.

In some embodiments the content and context information stored by plurality of users in an event may be stored in a server such as an event composition creation server. For viewing the event composition during or after the event, one or more users may get connected with each other to form a collaborative event composition viewing session. The connected individuals may choose their respective initial viewpoint in the event venue. Based on their contextual situation, the networked users may be mapped onto a micro-model of the event venue. This micro-model may be used to plot the changes in position of the viewers. The contextual position of the user determines the amount of his/her individual movement is translated to the change in viewpoint in the event venue. Depending on the viewpoint in the event venue, the crowd sourced composition is rendered for each user. For example, if a first viewer has chosen a viewpoint that is to the left of a stage and based on the derived micro-model and relative position of a second viewer, s/he may have a viewpoint that is to the right of the stage. Consequently, the first viewer and the second viewer may receive an event composition that is according to their respective viewpoints. A change in the viewpoint position of the second viewer (if s/he chooses to move or walk around to the other side) may end up having a change in the viewed event composition that corresponds to the new viewpoint.

### DESCRIPTION OF THE DRAWINGS

In the following, various embodiments will be described in more detail with reference to the appended drawings, in which

FIG. 1 shows a block diagram of an apparatus according to an example embodiment;

FIG. 2 shows an apparatus according to an example embodiment;

FIG. 3 shows an example of an arrangement for wireless communication comprising a plurality of apparatuses, networks and network elements;

FIG. 4 shows a block diagram of an apparatus usable as a s according to an example embodiment;

FIG. 5 shows a block diagram of an apparatus usable as a server according to an example embodiment;

FIGS. 6a-6e show example situations in which some embodiments may be used; and

FIG. 7 shows as a flow diagram of the operation of apparatuses according to an example embodiment.

### DETAILED DESCRIPTION OF SOME EXAMPLE EMBODIMENTS

In the following, several embodiments will be described in the context of multiple device media capturing for creating a collaborative content (also called as a content composition in this application) and ad hoc content consumption. It is to be noted, however, that the invention is not limited to the embodiments presented below. In fact, the different embodiments have applications widely in any environment where collecting content from multiple devices and retrieving parts of the collaborated content selectively to one or more devices is desired. Although the specification may refer to “an”, “one”, or “some” embodiment(s) in several locations, this does not necessarily mean that each such reference is to the same embodiment(s), or that the feature only applies to a single embodiment. Single features of different embodiments may also be combined to provide other embodiments.

In the following an event composition refers to a set of original or processed content captured from devices of one or more users attending an event, and a viewpoint represents the viewing perspective in the event venue's 3D space.

In some embodiments users may also be able to change their view position at any time and also review a viewed content from another perspective. It may also be possible to define which time instance of the original event they wish to play back. Hence, not only the viewpoint but also the instant of time may be selectable in some embodiments.

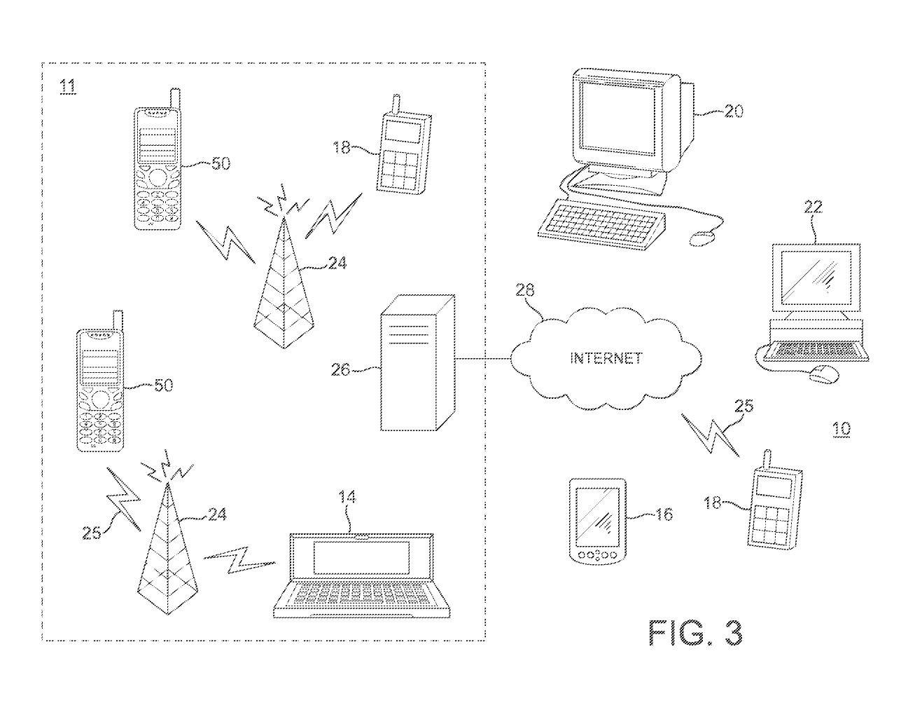

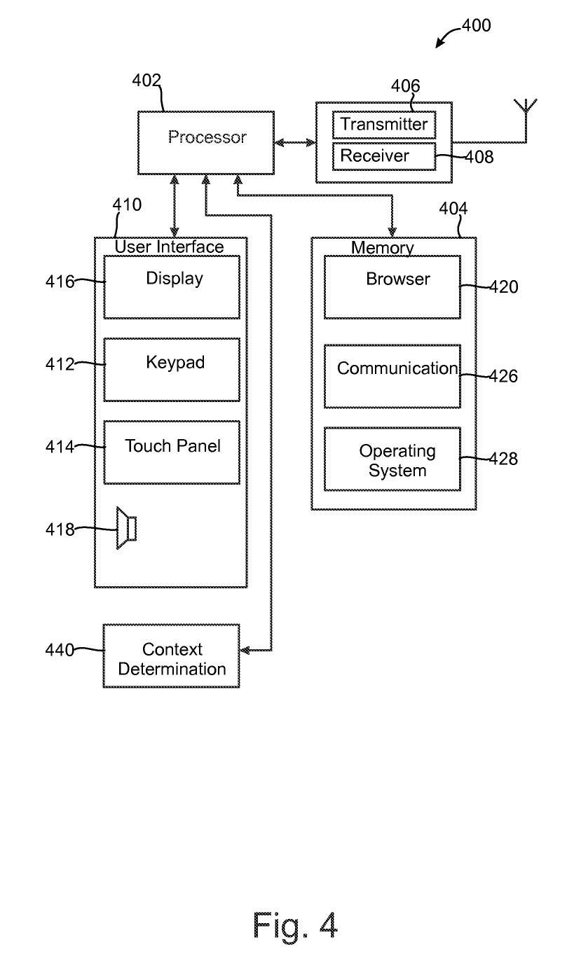

FIG. 4 depicts an example of some details of an apparatus 400 which can be used in a user device. The apparatus 400 comprises a processor 402 for controlling at least some of the operations of the apparatus 400, and a memory 404 for storing user data, computer program instructions, possible parameters, registers and/or other data. The apparatus 400 may further comprise a transmitter 406 and a receiver 408 for communicating with other devices and/or a wireless communication network e.g. via a base station 24 of the wireless communication network an example of which is depicted in FIG. 3. The apparatus 400 may also be equipped with a user interface 410 (UI) to enable the user of the apparatus 400 to enter commands, input data and dial a phone number, for example. For this purpose the user interface 410 may comprise a keypad 412, a touch sensitive element 414 and/or some other kinds of actuators. The user interface may also be used to provide the user some information in visual and/or in audible form e.g. by a display 416 and/or a loudspeaker 418. If the user interface 410 comprises the touch sensitive element 414, it may be positioned so that it is at least partly in front of the display 416 so that the display 416 can be used to present e.g. some information through the touch sensitive element 414 and the user can touch the touch sensitive element 414 at the location where the information is presented on the display 416.

The touch and the location of the touch may be detected by the touch sensitive element 414 and information on the touch and the location of the touch may be provided by the touch sensitive element 414 to the processor 402, for example. For this purpose, the touch sensitive element 414 may be equipped with a controller (not shown) which detects the signals generated by the touch sensitive element and deduces when a touch occurs and the location of the touch. In some other embodiments the touch sensitive element 414 provides some data regarding the location of the touch to the processor 402 wherein the processor 402 may use this data to determine the location of the touch. The combination of the touch sensitive element 414 and the display 416 may also be called as a touch screen.

In some embodiments the keypad 412 may be implemented without dedicated keys or keypads or the like e.g. by utilizing the touch sensitive element 414 and the display 416. For example, in a situation in which the user of the device is requested to enter some information, such as a telephone number, her/his personal identification number (PIN), a password etc., the corresponding keys (e.g. alphanumerical keys or telephone number dialing keys) may be shown by the display 416 and the touch sensitive element 414 may be operated to recognize which keys the user presses. Furthermore, although the keypad 412 would be implemented in this way, in some embodiments there may still exist one or more keys for specific purposes such as a power switch etc.

In some embodiments the touch sensitive element 414 may be able to detect more than one simultaneous touch and provide information on each of the touches (e.g. the location of each of the touches). The term simultaneous touch does not necessarily mean that each simultaneous touch begins and ends at the same time but that the simultaneous touches are at least partly overlapping in time.

When the processor 402 has received or determined information on the location of the touch the processor 402 may determine whether the touch should initiate an operation in the apparatus 400. For example, the detection of the touch may indicate that the user wants to share the document shown on the display 416 of the apparatus 400 at the location of the touch.

The user interface can be implemented in many different ways wherein the details of the operation of the user interface 410 may vary. For example, the user interface 410 may be implemented without the touch sensitive element wherein the keypad may be used to inform the apparatus 400 of a selection of a content to be delivered (shared) to one or more than one other device.

The apparatus 400 may further comprise a communication element 426 to provide encoding/decoding functionalities, packetizing/depacketizing operations and other operations to enable the transmitter 406 and the receiver 408 of the device to communicate with other devices and/or a communication network.

The apparatus 400 may also comprise a context determination element 440 to determine the context the user device is located and possible changes in the context. For example, the context determination element 440 may comprise one or more sensors or other elements for detecting position of the user device, compass orientation, gyroscope information, tilt using e.g. an accelerometer, altitude, or any other suitable sensor. The position may be a relative position with other recording user devices in an event or an absolute geo-location, or both.

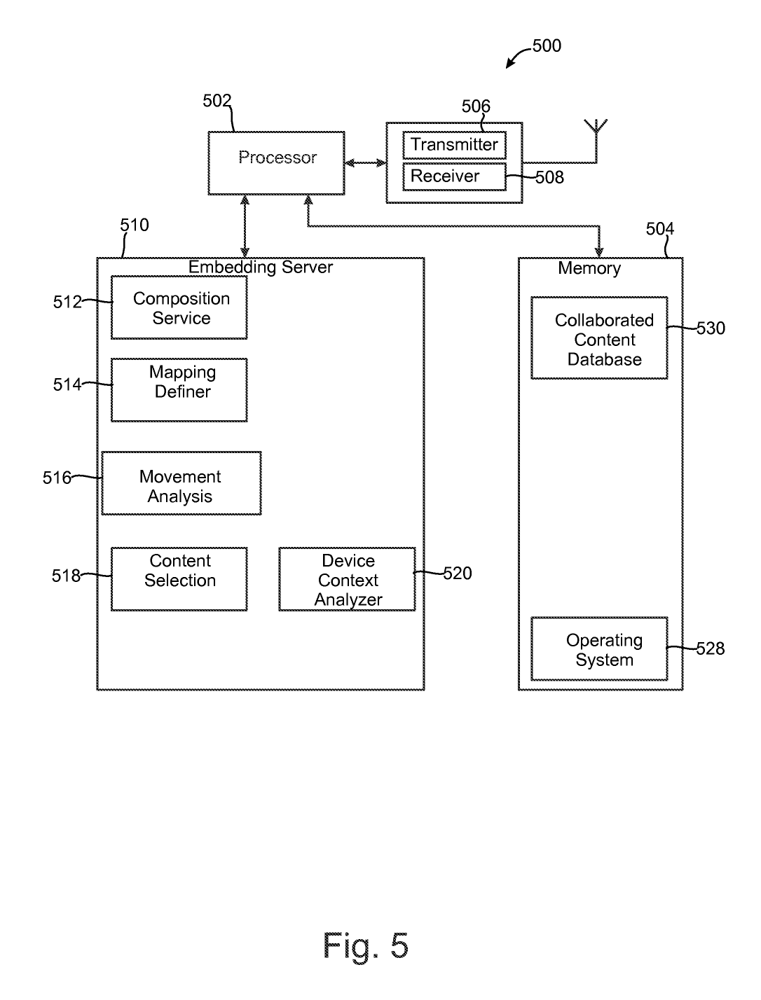

FIG. 5 depicts an example of some details of an apparatus 500 which can be used in a server 510. The apparatus 500 comprises a processor 502 for controlling at least some of the operations of the apparatus 500, and a memory 504 for storing user data, computer program instructions, possible parameters, registers and/or other data. The apparatus 500 may further comprise a transmitter 506 and a receiver 508 for communicating with other devices and/or a wireless communication network e.g. via a base station 24 of the wireless communication network.

The apparatus 500 may also comprise an embedding server 510. The embedding server 510 may include some functionalities for implementing the collaborated content provision. The functionalities may include, for example, a composition service 512 to form a collaborated content from individual contents from devices, a mapping defining element 514, a movement analysing element 516, a content selecting element 518, and a device context analyser 520. The memory 504 of the apparatus 500 may also comprise a collaborated content database 530 but it may also be external to the apparatus. Furthermore, the collaborated content database 530 need not be stored in one location but may be constructed in such a way that different parts of the collaborated content database 530 are stored in different locations in a network, e.g. in different servers.

The apparatuses 400, 500 may comprise groups of computer instructions (a.k.a. computer programs or software) for different kinds of operations to be executed by the processor 402, 502. Such groups of instructions may include instructions by which a content delivery element 420 may prepare video clips captured by the camera 46 and/or another forms of the content for transmission to the server 500, the context determination element 440 may receive signals from the sensors to determine the context of the user device and possible changes in the context, etc. The context determination element 440 may determine the context and send information of the context to the server 510 or the context determination element 440 may send some information provided by the context sensors to the server 510 in which the device context analyzer 520 may determine the context of the device.

The apparatuses 400, 500 may also comprise an operating system (OS) 428, 528, which is also a package of groups of computer instructions and may be used as a basic element in controlling the operation of the apparatus. Hence, the starting and stopping of daemons and other computer programs, changing status of them, assigning processor time for them etc. may be controlled by the operating system. Description of further details of actual implementations and operating principles of computer software and operating systems is not necessary in this context.

The user device may also be provided with local (short range) wireless communication means, such as Bluetooth TM communication means, near field communication means (Nfc) and/or communication means for communicating with a wireless local area network (WLAN).

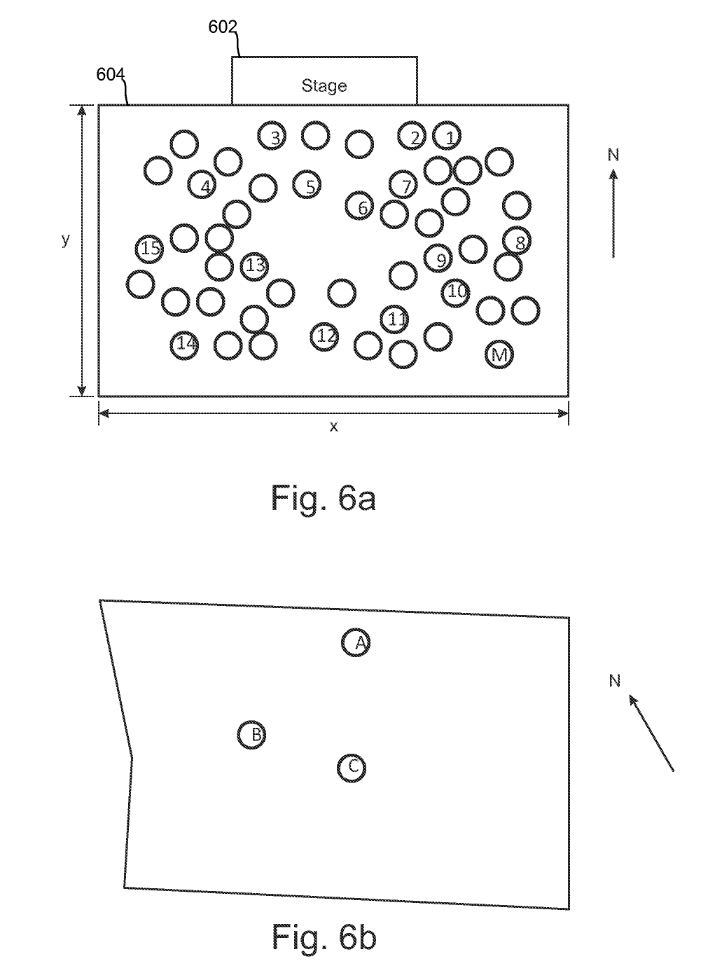

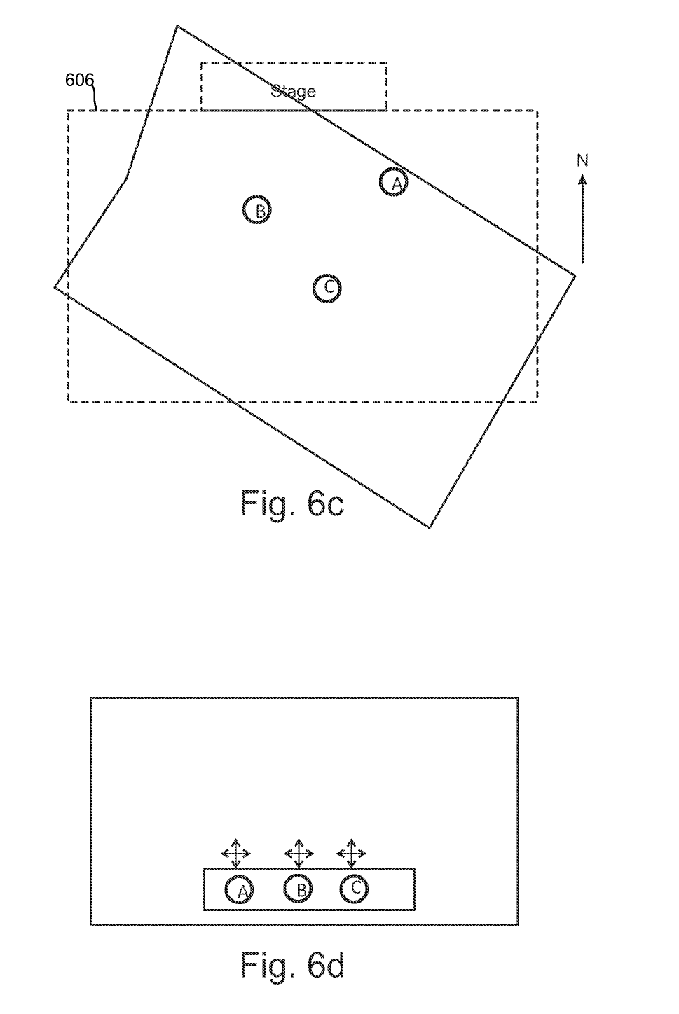

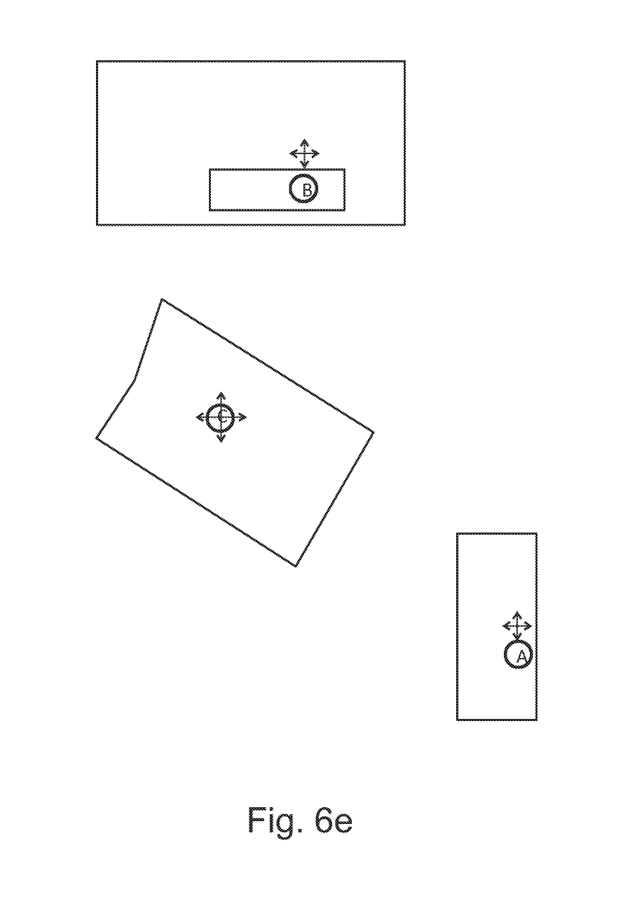

In the following, some non-limiting example situations in which the invention may be used are described in more detail. In these examples it is assumed that a plurality of people (users) attend an event and at least some of the attendees have a user device capable of capturing content from the event. A non-limiting example of a setup in the event is depicted in FIG. 6a. It is assumed that there is a stage 602 for performers of the event and a certain geographical area 604 is reserved for attending the event. The geographical area 604 need not be in a rectangular form as depicted in FIG. 6a but may also have another form. However, for clarity it is assumed here that the geographical area 604 has a certain width x and length y so that the location of user devices within the geographical area 604 can be expressed as co-ordinates (x,y). In FIG. 6a the attendees are depicted as circles and those attendees who are capturing content at least a part of the time of the event are depicted with numbered circles. When the devices of the attendees are capturing content, the devices may also determine the location of the device and send the content and the location information along with any relevant other sensor information to a server 510. The server stores the content and the context attached with the content so that the server 510 can determine which of the contents from multiple user devices are captured in the event and in which location and also the time of capturing. Therefore, the server 510 can determine the viewpoint each content is representing. As an example, the location of the content capturing attendee represented with number 1 and capturing content can be expressed as (x₁, y₁), the location of the content capturing attendee represented with number 2 can be expressed as (x₁, y₁), . . . , location of the content capturing attendee represented with number M can be expressed as (x_{M}, y_{M}), etc.

The server 510 receives the contents and the context attached with the content and may use the context to examine which content belong to the same event and could hence be inserted into the same collaborated content. The content inserted into the collaborated content may also be attached with the position information of the user device from which the content was received. When examining the context of a content the server 510 may determine that the content from a device is not captured within the geographical area defined for the event. For example, the user of the device may have moved to a location which is outside the area of the event. Hence, the content may not be included in the same collaborated content.

When the collaborated content has been constructed it may be retrieved to one or more user devices. In the following some use examples of this are provided.

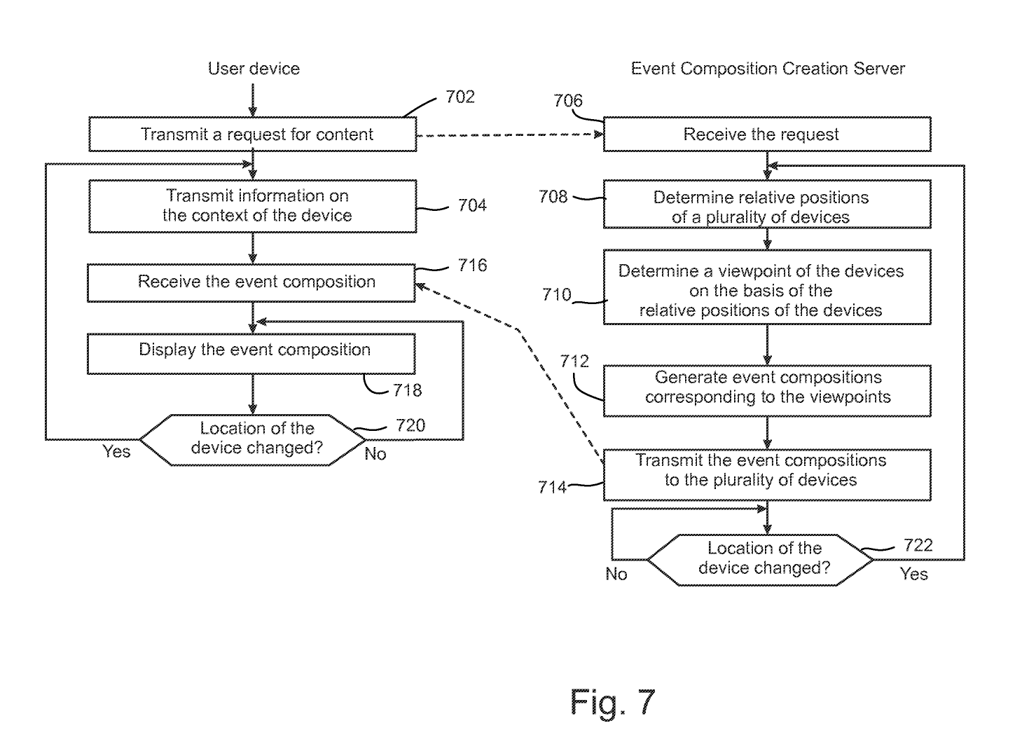

In a first use scenario it is assumed that some friends wanted to experience the event again and watch some content captured during the event. Let's call these friends as user A, user B and user C. The users A, B, C may be located in different positions in the same park 606. Let's call this kind of situation as a replay situation and the corresponding constellation as a replay constellation. FIG. 6b depicts an example constellation of this kind of situation. The user A, for example, may first select the viewpoint s/he wants to see. In this example the viewpoint which the other users B, C will see depends on their location with respect to the location of user A and the viewpoint the user A selected. The user A may have selected e.g. the location of the capturing attendee represented with number 2 in FIG. 6a. The device of user A may then transmit (block 702 in FIG. 7) a request for event composition and also information on the context of the device (block 704) indicative of at least the location of the device. The server 510 may receive the request (706) and the context, wherein the server 510 may generate (712) an event composition for user A on the basis of the content captured by the capturing attendee represented with number 2 and transmit (714) contents of the event composition to the device of user A. The device of user A may receive (716) the event composition and present it to the user e.g. by displaying (718) a video clip and generating audible signals on the basis of a possible audio clip of the event composition.

When the locations of users are known, a micro-model may be generated to map the real-world venue (the original venue) for which the event composition was generated to the plurality of users A, B, C in their current positions. For example, the server 510 examines the current locations of the users A, B, C (block 708) and determines (block 710) that the location of the user B with respect to users A and C could correspond with the location of the capturing attendee represented with number 4 in FIG. 6a, and the location of the user C with respect to users A and B could correspond the location of the capturing attendee represented with number 12 in FIG. 6a. The determination of the locations of users B, C may need some comparison of different constellations. For example, the server 510 may examine some or all of the locations of capturing attendees to determine which locations match best with the current constellation of users A, B, C. When found an appropriate constellation, the server 510 may generate an event composition for user B on the basis of the content captured by the capturing attendee represented with number 4 for transmission to the device of the user B and, respectively, the server 510 may generate an event composition for user C on the basis of the content captured by the capturing attendee represented with number 12 for transmission to the device of the user C. Then, if any of the users A, B, C wishes to see content captured from another viewpoint in the event s/he may move to another location in the park. For example, if the user B would like to see how the event looked like at the location where the attendee represented with number 13 was located during the event, the user B might move towards the user C until s/he reaches the location in the park which corresponds with the position of circle 13 in FIG. 6a. On the other hand, if the user A would like to see the viewpoint of the attendee represented with number 7 the user A might move a little bit towards user's C current location.

The initial locations selected by a user or otherwise determined may also be called as reference locations in this application. In the example above the location selected by user A could also be called as the reference location of user A, and the locations of users B and C determined by the server could also be called as the reference locations of users B and C.

In other words, the constellation of users A, B, C when they begin to play back the content and the initial selection of the location by user A can be used to determine the initial viewpoints of users A, B, C in the original event venue. This kind of procedure may also be called as mapping the original event venue to an imaginary venue of the original event. In the mapping a scaling procedure may be performed wherein the original area of the event venue may be different from the situation in which the content is played back (“consumed”) by devices of users A, B, C. In FIG. 6c the imaginary original venue is depicted with dotted lines 606.

When the constellation of users A, B, C is compared to the original constellation of the event venue, a scaling may be needed. For example, the distance between users A and B may not be same than the distance between the location of the capturing attendee represented with number 2 and the location of the capturing attendee represented with number 4 in the original constellation. It is also not necessary that the headings of the users in the replay constellation are not towards the same compass directions than the headings of the corresponding attendees in the original venue. In other words, if the stage of the original venue were, for example, heading towards south, in the replay constellation the imaginary location of the stage need not be heading to the south but it may be determined on the basis of the replay constellation. In the examples of FIGS. 6a, 6b and 6c the north is depicted with an arrow N.

The movements after the initial selection can be used to change viewpoints of users A, B, C (blocks 720, 722). Due to the movements a new perspective may be generated corresponding to the new location. The movement information of devices of users A, B, C may be periodically transmitted by the devices to the server 510 or the server may determine this from other sources, e.g. from a mobile communication network. The movements of the users A, B, C may also need to be scaled to correspond with the original scale of the venue. For example, if the scaling factor were 0.5, the movement of 1 meter in the replay situation would correspond with the movement of 2 meters in the original venue.

In some situations it may occur that the user may move outside the imaginary venue wherein transmission of the content may be stopped or the transmitted content is from the latest viewpoint which were inside the imaginary venue.

In some embodiments the event compositions may be constructed directly from the media clips captured by the original attendees and possibly stored by the server 510. In some other embodiments the event compositions may be constructed by combining two or more of the original media clips and possibly by synthesizing different viewpoints from two or more other views, especially if a viewpoint does not exist in the original content. In the construction of event compositions depth maps and distance of depth of field, or other depth-related information may be used. Depth maps may be generated on the basis of two or more different video clips provided that the location of the devices which have captured the video clips are known to determine e.g. the baseline and distance between these devices.

In a second use example the users A, B, C are in the same room and are, for example, sitting next to each other, as depicted in FIG. 6d. In this example each user A, B, C may select her/his viewpoint from the selectable viewpoints of an event, wherein event compositions corresponding to the selected viewpoint may then be generated, if necessary, and transmitted to the devices of users A, B, C. Users A, B, C may then move in the event venue by e.g.

moving their devices in their hands. In other words, the movement gestures may define changes in viewpoints in the original venue. For example, rotating a device to the left might correspond with moving in the event venue to the left from the previous location, tilting the device in the longitudinal direction could correspond with forward/backward movement. Hence, if the “imaginary” movement leads to a different viewpoint, the new event composition corresponding this viewpoint may then be generated and transmitted to the device.

In some embodiments the movement gestures may be provided by using the touch panel. For example, sliding a finger to the left on the surface of the touch panel might indicate that the user desires to move to the left in the simulated event venue.

The movement of the device may be detected e.g. by the context determination element 440. For example, if the device is tilted or rotated so that the inclination angle of the device changes, the gyroscope may detect this and generate a signal to the context determination element 440 which uses the information contained in the signal to determine the direction of movement. The context determination element 440 may also determine the length of the movement e.g. on the basis of the duration of the tilt.

In some embodiments of the second use case the users may also walk in the room to change their viewpoint. This may require a kind of a location system within the room so that the changes in the locations of the devices could be detected with enough accuracy.

In a third use example the users A, B, C are in different locations, as depicted in FIG. 6e. For example, user A is travelling, e.g. riding a bus or a train, user B is at home, and user C is walking outside, e.g. in a park. In this kind of situation the relative movements of the users may not be possible to determine the event compositions of the users but a different logic for each user or some of the users may be needed. In this example user A is moving all the time when the vehicle (bus, train, etc.) is moving and the space in which the user is able to move may be very restricted (the user may even have to sit in her/his place all the time during the travel). Hence, changes in event compositions may be based on e.g. how the user moves the device in the hand or how the user enters gestures on the touch panel. Also the user B, who is at home, may have restricted space for moving and the movement gestures of the device can be used to determine possible changes in event compositions. User C is in park in this example and thus may have more freedom for moving compared to users A and B. Thus, the actual changes of the location of user C may be used to determine the changes in event compositions of user C.

As can be seen from the above examples, there are many kinds of situations in which the users may consume the contents of previous events and different kinds of methods may be used to imitate movements of users in the original event venue and thus experience different viewpoints.

In some embodiments it may even be possible to use contents captured at different locations during the event to synthesize contents for locations in which no content has actually been captured. In the example of FIG. 6a such locations are those in which no numbered circles exist. This kind of synthesized content may be relatively continuous during the user is moving in the area so that the user can get a feeling that s/he is moving in the area of the event venue.

In the first use case presented above the scale was determined on the basis of the relative positions of the users in the park. However, in some embodiments the scale of movements may be predetermined for certain locations. For example, a scale may have been defined for the park so that when the users gather together in the park to consume the contents the actual movement may each time be scaled in the same way. Alternatively, a different scale may be predetermined for different events wherein when consuming one event a smaller scale may use than in a situation in which another event is consumed.

It may also be possible that the user may define the scale for her/himself. For example, one of the users might want to use a smaller scaling factor so that s/he need not walk so much in the park to simulate different viewpoints of the original event.

There may also be some predetermined context and scaling factors for the contexts from which the user may select or which may be selected automatically by analyzing the context of the device. As an example, if the context determination element 440 determines that the device is moving all the time and the speed of movement is faster than normal walking speed, the context determination element 440 may determine that the device is in a vehicle and the corresponding context may be selected for that device.

In some embodiments the users may be able to define the instant of time from which they wish to start playback of the content. Each of the users may, for example, select the time instance s/he wants to start playback, or the users may collectively decide the time instance and one of the users may then indicate the time instance by her/his device to inform e.g. the server 510 of the time instant. For example, the instant of time may be indicated as a time relative to the beginning of the event or to the beginning of the capturing the content. In some embodiments the instant of time may also be indicated as a wall clock time i.e. the time when the event took place.

Although the examples presented above described how content relating to a previously occurred event could be reviewed by a group of users it may also be possible to review a live content in a substantially similar way. Hence, the event compositions may be constructed using live media and/or previously stored media presentations.

In some embodiments one or more users may get connected with each other to form a collaborative event composition viewing session e.g. by forming a communication network, such as an ad-hoc network or another (local) communication network, which may also communicate with the server 510. The server 510 may use information of the participants of the network to determine which user devices belong to the collaborative event composition viewing session. Hence, for example in the first use scenario, the server 510 can perform the determination of the constellation of users and the comparison of the constellation with the original constellation of the event venue when the server 510 has received an indication of the selection of the viewpoint from one of the participants of the collaborative event composition viewing session.

If, however, the participants of the collaborative event composition viewing session do not form the communication network, the participants may use other means to indicate the server 510 which user devices belong to the same collaborative event composition viewing session.

In some embodiments participants of a collaborative event composition viewing session may have been informed beforehand and stored to the server 510.

The received content may e.g. be stored to a memory of the destination device or to a storage media to which the destination device is able to write data.

In some other embodiments the collaborative content, which may have been generated and stored by the server 510, may be transmitted to the user devices when they are beginning to consume the event. In this case the user devices may generate the event compositions corresponding to the changes in the locations of the user devices. Therefore, the server 510 need to be contacted by the devices after loading the collaborated content.

In yet some embodiments the server 510 may not be needed but the operations are performed by one or more user devices so that the user device receives location information from other user devices and deduce the relative locations of the users and generates corresponding event compositions for the user devices. The generated event compositions may be transmitted to the other user devices. The original collaborated content may have been stored into a database from which the collaborated content may be downloaded to the user device or user devices at the beginning of the consumption of the content.

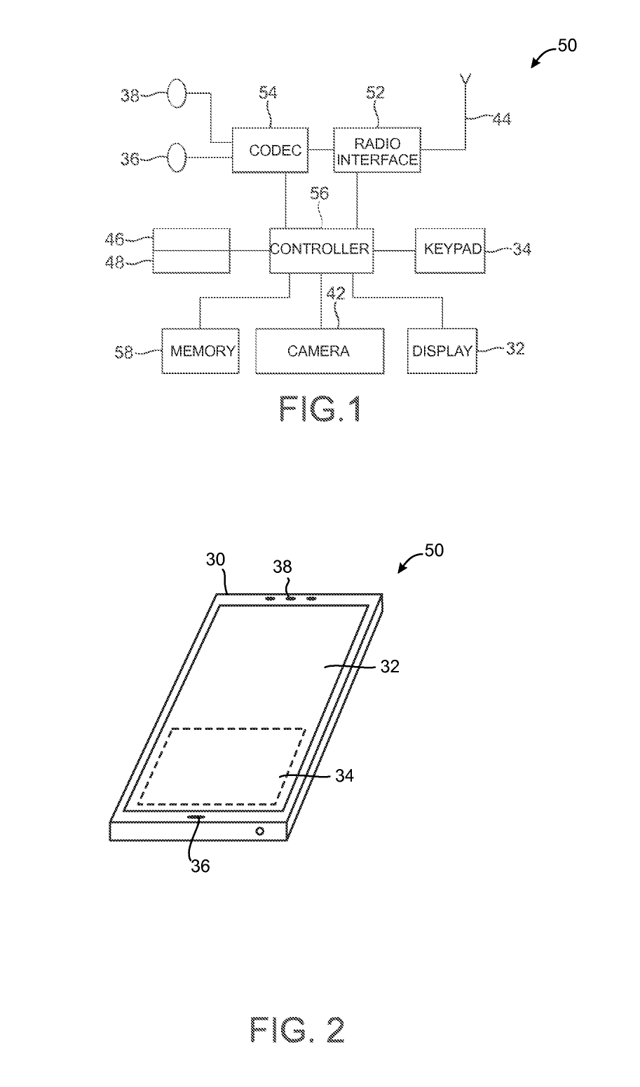

The following describes in further detail suitable apparatus and possible mechanisms for implementing the embodiments of the invention. In this regard reference is first made to FIG. 1 which shows a schematic block diagram of an exemplary apparatus or electronic device 50 depicted in FIG. 2, which may incorporate content delivery functionality according to some embodiments of the invention.

The electronic device 50 may for example be a mobile terminal or user equipment of a wireless communication system. However, it would be appreciated that embodiments of the invention may be implemented within any electronic device or apparatus which may utilize content delivery operations, either by setting content available for delivery and transmitting the content and/or by receiving the content.

The apparatus 50 may comprise a housing 30 for incorporating and protecting the device. The apparatus 50 may further comprise a display 32 e.g. in the form of a liquid crystal display, a light emitting diode (LED) display, an organic light emitting diode (OLED) display. In other embodiments of the invention the display may be any suitable display technology suitable to display information. The apparatus 50 may further comprise a keypad 34, which may be implemented by using keys or by using a touch screen of the electronic device. In other embodiments of the invention any suitable data or user interface mechanism may be employed. For example the user interface may be implemented as a virtual keyboard or data entry system as part of a touch-sensitive display. The apparatus may comprise a microphone 36 or any suitable audio input which may be a digital or analogue signal input. The apparatus 50 may further comprise an audio output device which in embodiments of the invention may be any one of: an earpiece 38, speaker, or an analogue audio or digital audio output connection. The apparatus 50 may also comprise a battery (not shown) (or in other embodiments of the invention the device may be powered by any suitable mobile energy device such as solar cell, fuel cell or clockwork generator). The apparatus may further comprise the camera 42 capable of recording or capturing images and/or video. In some embodiments the apparatus 50 may further comprise any suitable short range communication solution such as for example a Bluetooth wireless connection or a USB/firewire wired connection or an infrared port for short range line of sight optical connection.

The apparatus 50 may comprise a controller 56 or processor for controlling the apparatus 50. The controller 56 may be connected to memory 58 which in embodiments of the invention may store both data and/or may also store instructions for implementation on the controller 56. The controller 56 may further be connected to codec circuitry 54 suitable for carrying out coding and decoding of audio and/or video data or assisting in coding and decoding carried out by the controller 56.

The apparatus 50 may further comprise a card reader 48 and a smart card 46, for example a UICC and UICC reader for providing user information and being suitable for providing authentication information for authentication and authorization of the user at a network.

The apparatus 50 may comprise one or more radio interface circuitries 52 connected to the controller and suitable for generating wireless communication signals for example for communication with a cellular communications network, a wireless communications system or a wireless local area network and/or with devices utilizing e.g. Bluetooth™ technology. The apparatus 50 may further comprise an antenna 44 connected to the radio interface circuitry 52 for transmitting radio frequency signals generated at the radio interface circuitry 52 to other apparatus(es) and for receiving radio frequency signals from other apparatus(es).

With respect to FIG. 3, an example of a system within which embodiments of the present invention can be utilized is shown. The system 10 comprises multiple communication devices which can communicate through one or more networks. The system 10 may comprise any combination of wired or wireless networks including, but not limited to a wireless cellular telephone network (such as a GSM, UMTS, CDMA network etc.), a wireless local area network (WLAN) such as defined by any of the IEEE 802.x standards, a Bluetooth personal area network, an Ethernet local area network, a token ring local area network, a wide area network, and the Internet.

The system 10 may include both wired and wireless communication devices or apparatus 50 suitable for implementing embodiments of the invention.

For example, the system shown in FIG. 3 shows a mobile telephone network 11 and a representation of the internet 28. Connectivity to the internet 28 may include, but is not limited to, long range wireless connections, short range wireless connections, and various wired connections including, but not limited to, telephone lines, cable lines, power lines, and similar communication pathways.

The example communication devices shown in the system 10 may include, but are not limited to, an electronic device or apparatus 50, a combination of a personal digital assistant (PDA) and a mobile telephone 14, a PDA 16, an integrated messaging device (IMD) 18, a desktop computer 20, a notebook computer 22. The apparatus 50 may be stationary or mobile when carried by an individual who is moving. The apparatus 50 may also be located in a mode of transport including, but not limited to, a car, a truck, a taxi, a bus, a train, a boat, an airplane, a bicycle, a motorcycle or any similar suitable mode of transport.

Some or further apparatus may send and receive calls and messages and communicate with service providers through a wireless connection 25 to a base station 24. The base station 24 may be connected to a network server 26 that allows communication between the mobile telephone network 11 and the internet 28. The system may include additional communication devices and communication devices of various types.

The communication devices may communicate using various transmission technologies including, but not limited to, code division multiple access (CDMA), global systems for mobile communications (GSM), universal mobile telecommunications system (UMTS), time divisional multiple access (TDMA), frequency division multiple access (FDMA), transmission control protocol-internet protocol (TCP-IP), short messaging service (SMS), multimedia messaging service (MMS), email, instant messaging service (IMS), Bluetooth, IEEE 802.11 and any similar wireless communication technology. A communications device involved in implementing various embodiments of the present invention may communicate using various media including, but not limited to, radio, infrared, laser, cable connections, and any suitable connection.

Although the above examples describe embodiments of the invention operating within an apparatus within an electronic device, it would be appreciated that the invention as described below may be implemented as part of any apparatus comprising a processor or similar element. Thus, for example, embodiments of the invention may be implemented in a wireless communication device. In some embodiments of the invention the apparatus need not comprise the communication means but may comprise an interface to input and output data to communication means external to the apparatus. As an example, the touch and share operations or part of them may be implemented in a software of a tablet computer, which may be connected to e.g. a Bluetooth adapter which contains means for enabling short range communication with other devices in the proximity supporting Bluetooth communication technology. As another example, the apparatus may be connected with a mobile phone to enable communication with other devices e.g. in the cloud model.

It shall be appreciated that the term user equipment is intended to cover any suitable type of wireless communication device, such as mobile telephones, portable data processing devices or portable web browsers.

Furthermore elements of a public land mobile network (PLMN) may also comprise transceivers as described above.

In general, the various embodiments of the invention may be implemented in hardware or special purpose circuits, software, logic or any combination thereof. For example, some aspects may be implemented in hardware, while other aspects may be implemented in firmware or software which may be executed by a controller, microprocessor or other computing device, although the invention is not limited thereto. While various aspects of the invention may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

The embodiments of this invention may be implemented by computer software executable by a data processor of the apparatus, such as in the processor entity, or by hardware, or by a combination of software and hardware. Further in this regard it should be noted that any blocks of the logic flow as in the Figures may represent program steps, or interconnected logic circuits, blocks and functions, or a combination of program steps and logic circuits, blocks and functions. The software may be stored on such physical media as memory chips, or memory blocks implemented within the processor, magnetic media such as hard disk or floppy disks, and optical media such as for example DVD and the data variants thereof, CD.

The memory may be of any type suitable to the local technical environment and may be implemented using any suitable data storage technology, such as semiconductor based memory devices, magnetic memory devices and systems, optical memory devices and systems, fixed memory and removable memory. The data processors may be of any type suitable to the local technical environment, and may include one or more of general purpose computers, special purpose computers, microprocessors, digital signal processors (DSPs) and processors based on multi core processor architecture, as non-limiting examples.

Embodiments of the inventions may be practiced in various components such as integrated circuit modules. The design of integrated circuits is by and large a highly automated process. Complex and powerful software tools are available for converting a logic level design into a semiconductor circuit design ready to be etched and formed on a semiconductor substrate.

Programs, such as those provided by Synopsys, Inc. of Mountain View, California and Cadence Design, of San Jose, California automatically route conductors and locate components on a semiconductor chip using well established rules of design as well as libraries of pre stored design modules. Once the design for a semiconductor circuit has been completed, the resultant design, in a standardized electronic format (e.g., Opus, GDSII, or the like) may be transmitted to a semiconductor fabrication facility or “fab” for fabrication.

The foregoing description has provided by way of exemplary and non-limiting examples a full and informative description of the exemplary embodiment of this invention. However, various modifications and adaptations may become apparent to those skilled in the relevant arts in view of the foregoing description, when read in conjunction with the accompanying drawings and the appended claims. However, all such and similar modifications of the teachings of this invention will still fall within the scope of this invention.

In the following, some examples will be provided.

According to a first example there is provided a method comprising:
receiving a request for transmitting content relating to a collaborated content to a first device, the collaborated content comprising one or more media clips of an event attached with information on a context regarding capturing of the media clips;
obtaining information on the context of the first device;
determining a viewpoint of the first device in the collaborated content on the basis of a relationship between the context of the first device and the context regarding capturing of the media clips; and
generating an event composition from the one or more media clips of the collaborated content representing the determined viewpoint.

In some embodiments of the method the information on context regarding capturing of the media clips comprising information of a constellation of one or more devices which captured the media clips.

In some embodiments the method further comprises obtaining information on the context of a second device.

In some embodiments the method further comprises forming a positional network between the first device and the second device.

In some embodiments the method further comprises:
using the information on the context of the first device and the information on the context of the second device to determine the constellation of the first device and the second device; and
comparing the determined constellation with the information of the constellation of one or more devices which captured the media clips to determine which devices in the constellation of one or more devices which captured the media clips correspond with the constellation of the first device and the second device.

In some embodiments the method further comprises:
using the information of a constellation of one or more devices which captured the media clips to determine a first distance representative of a distance between at least two devices which captured the media clips;
using the constellation of the first device and the second device to determine a second distance representative of a distance between the first device and the second device; and
determining a scaling factor on the basis of the first distance and the second distance.

In some embodiments the method further comprises:
receiving information of changes of context of the first device; and
reflecting the changes in the first device in the generation of the event composition.

In some embodiments of the method the information on changes of context of the first device comprises information regarding at least one of the following:
a change of the location of the first device;
a change of the inclination angle of the first device;
a gesture entered by a user of the first device and detected by a user interface of the first device.

In some embodiments the method further comprises:
synthesizing the event composition on the basis of two or more media clips of the collaborated content, if the relationship between the context of the first device and the context regarding capturing of the media clip indicates that a media clip corresponding to the determined viewpoint does not exist in the collaborated content.

In some embodiments the method further comprises selecting a media clip captured at a viewpoint nearest the viewpoint of the first device to the event composition, if the relationship between the context of the first device and the context regarding capturing of the media clip indicates that a media clip corresponding to the determined viewpoint does not exist in the collaborated content.

In some embodiments of the method obtaining the information on the context of the first device comprises receiving from the first device an indication of a selection of the viewpoint.

In some embodiments of the method obtaining the information on the context of the second device comprises receiving from the second device an indication of a selection of a viewpoint of the second device.

In some embodiments of the method the media clips of the event comprises at least a video clip.

According to a second example there is provided an apparatus comprising at least one processor and at least one memory including computer program code, the at least one memory and the computer program code configured to, with the at least one processor, cause the apparatus to perform at least the following:
receive a request for transmitting content relating to a collaborated content to a first device, the collaborated content comprising one or more media clips of an event attached with information on a context regarding capturing of the media clips;
obtain information on the context of the first device;
determine a viewpoint of the first device in the collaborated content on the basis of a relationship between the context of the first device and the context regarding capturing of the media clips; and
generate an event composition from the one or more media clips of the collaborated content representing the determined viewpoint.

In some embodiments of the apparatus the information on context regarding capturing of the media clips comprising information of a constellation of one or more devices which captured the media clips.

In some embodiments the apparatus further comprises computer program code configured to, with the processor, cause the apparatus to obtain information on the context of a second device.

In some embodiments the apparatus further comprises computer program code configured to, with the processor, cause the apparatus to form a positional network between the first device and the second device.

In some embodiments the apparatus further comprises computer program code configured to, with the processor, cause the apparatus to:
use the information on the context of the first device and the information on the context of the second device to determine the constellation of the first device and the second device; and
compare the determined constellation with the information of the constellation of one or more devices which captured the media clips to determine which devices in the constellation of one or more devices which captured the media clips correspond with the constellation of the first device and the second device.

In some embodiments the apparatus further comprises computer program code configured to, with the processor, cause the apparatus to:
use the information of a constellation of one or more devices which captured the media clips to determine a first distance representative of a distance between at least two devices which captured the media clips;
use the constellation of the first device and the second device to determine a second distance representative of a distance between the first device and the second device; and
determine a scaling factor on the basis of the first distance and the second distance.

In some embodiments the apparatus further comprises computer program code configured to, with the processor, cause the apparatus to:
receive information of changes of context of the first device; and
reflect the changes in the first device in the generation of the event composition.

In some embodiments of the apparatus the information on changes of context of the first device comprises information regarding at least one of the following:
a change of the location of the first device;
a change of the inclination angle of the first device;
a gesture entered by a user of the first device and detected by a user interface of the first device.

In some embodiments the apparatus further comprises computer program code configured to, with the processor, cause the apparatus to:
synthesize the event composition on the basis of two or more media clips of the collaborated content, if the relationship between the context of the first device and the context regarding capturing of the media clip indicates that a media clip corresponding to the determined viewpoint does not exist in the collaborated content.

In some embodiments the apparatus further comprises computer program code configured to, with the processor, cause the apparatus to select a media clip captured at a viewpoint nearest the viewpoint of the first device to the event composition, if the relationship between the context of the first device and the context regarding capturing of the media clip indicates that a media clip corresponding to the determined viewpoint does not exist in the collaborated content.

In some embodiments of the apparatus obtaining the information on the context of the first device comprises computer program code configured to, with the processor, cause the apparatus to receive from the first device an indication of a selection of the viewpoint.

In some embodiments of the apparatus obtaining the information on the context of the second device comprises computer program code configured to, with the processor, cause the apparatus to receive from the second device an indication of a selection of a viewpoint of the second device.

In some embodiments of the apparatus the media clips of the event comprises at least a video clip.

In some embodiments the apparatus comprises a communication device comprising:
a user interface circuitry and user interface software configured to facilitate a user to control at least one function of the communication device through use of a display and further configured to respond to user inputs; and
a display circuitry configured to display at least a portion of a user interface of the communication device, the display and display circuitry configured to facilitate the user to control at least one function of the communication device.

In some embodiments the communication device comprises a mobile phone.

According to a third example there is provided computer program comprising one or more sequences of one or more instructions which, when executed by one or more processors, cause an apparatus to perform at least the following:
receive a request for transmitting content relating to a collaborated content to a first device, the collaborated content comprising one or more media clips of an event attached with information on a context regarding capturing of the media clips;
obtain information on the context of the first device;
determine a viewpoint of the first device in the collaborated content on the basis of a relationship between the context of the first device and the context regarding capturing of the media clips; and
generate an event composition from the one or more media clips of the collaborated content representing the determined viewpoint.

In some embodiments of the computer program the information on context regarding capturing of the media clips comprising information of a constellation of one or more devices which captured the media clips.

In some embodiments the computer program further comprises one or more sequences of one or more instructions which, when executed by one or more processors, cause the apparatus to obtain information on the context of a second device.

In some embodiments the computer program further comprises one or more sequences of one or more instructions which, when executed by one or more processors, cause the apparatus to form a positional network between the first device and the second device.

In some embodiments the computer program further comprises one or more sequences of one or more instructions which, when executed by one or more processors, cause the apparatus to:
use the information on the context of the first device and the information on the context of the second device to determine the constellation of the first device and the second device; and
compare the determined constellation with the information of the constellation of one or more devices which captured the media clips to determine which devices in the constellation of one or more devices which captured the media clips correspond with the constellation of the first device and the second device.

In some embodiments the computer program further comprises one or more sequences of one or more instructions which, when executed by one or more processors, cause the apparatus to:
use the information of a constellation of one or more devices which captured the media clips to determine a first distance representative of a distance between at least two devices which captured the media clips;
use the constellation of the first device and the second device to determine a second distance representative of a distance between the first device and the second device; and determine a scaling factor on the basis of the first distance and the second distance.

In some embodiments the computer program further comprises one or more sequences of one or more instructions which, when executed by one or more processors, cause the apparatus to:
receive information of changes of context of the first device; and
reflect the changes in the first device in the generation of the event composition.

In some embodiments of the computer program the information on changes of context of the first device comprises information regarding at least one of the following:
a change of the location of the first device;
a change of the inclination angle of the first device;
a gesture entered by a user of the first device and detected by a user interface of the first device.

In some embodiments the computer program further comprises one or more sequences of one or more instructions which, when executed by one or more processors, cause the apparatus to:
synthesize the event composition on the basis of two or more media clips of the collaborated content, if the relationship between the context of the first device and the context regarding capturing of the media clip indicates that a media clip corresponding to the determined viewpoint does not exist in the collaborated content.

In some embodiments the computer program further comprises one or more sequences of one or more instructions which, when executed by one or more processors, cause the apparatus to select a media clip captured at a viewpoint nearest the viewpoint of the first device to the event composition, if the relationship between the context of the first device and the context regarding capturing of the media clip indicates that a media clip corresponding to the determined viewpoint does not exist in the collaborated content.

In some embodiments of the computer program obtaining the information on the context of the first device comprising one or more sequences of one or more instructions which, when executed by one or more processors, cause the apparatus to receive from the first device an indication of a selection of the viewpoint.

In some embodiments of the computer program obtaining the information on the context of the second device comprising one or more sequences of one or more instructions which, when executed by one or more processors, cause the apparatus to receive from the second device an indication of a selection of a viewpoint of the second device.

In some embodiments of the computer program the media clips of the event comprises at least a video clip.

In some embodiments the computer program is comprised in a computer readable memory.

In some embodiments of the computer program the computer readable memory comprises a non-transient computer readable storage medium.

According to a fourth example there is provided an apparatus comprising:
means for receiving a request for transmitting content relating to a collaborated content to a first device, the collaborated content comprising one or more media clips of an event attached with information on a context regarding capturing of the media clips;
means for obtaining information on the context of the first device;
means for determining a viewpoint of the first device in the collaborated content on the basis of a relationship between the context of the first device and the context regarding capturing of the media clips; and
means for generating an event composition from the one or more media clips of the collaborated content representing the determined viewpoint.

In some embodiments of the apparatus the information on context regarding capturing of the media clips comprising information of a constellation of one or more devices which captured the media clips.

In some embodiments the apparatus further comprises means for obtaining information on the context of a second device.

In some embodiments the apparatus further comprises means for forming a positional network between the first device and the second device.

In some embodiments the apparatus further comprises:
means for using the information on the context of the first device and the information on the context of the second device to determine the constellation of the first device and the second device; and
means for comparing the determined constellation with the information of the constellation of one or more devices which captured the media clips to determine which devices in the constellation of one or more devices which captured the media clips correspond with the constellation of the first device and the second device.

In some embodiments the apparatus further comprises:
means for using the information of a constellation of one or more devices which captured the media clips to determine a first distance representative of a distance between at least two devices which captured the media clips;
means for using the constellation of the first device and the second device to determine a second distance representative of a distance between the first device and the second device; and
means for determining a scaling factor on the basis of the first distance and the second distance.

In some embodiments the apparatus further comprises:
means for receiving information of changes of context of the first device; and
means for reflecting the changes in the first device in the generation of the event composition.

In some embodiments of the apparatus the information on changes of context of the first device comprises information regarding at least one of the following:
a change of the location of the first device;
a change of the inclination angle of the first device;
a gesture entered by a user of the first device and detected by a user interface of the first device.

In some embodiments the apparatus further comprises:
means for synthesizing the event composition on the basis of two or more media clips of the collaborated content, if the relationship between the context of the first device and the context regarding capturing of the media clip indicates that a media clip corresponding to the determined viewpoint does not exist in the collaborated content.

In some embodiments the apparatus further comprises means for selecting a media clip captured at a viewpoint nearest the viewpoint of the first device to the event composition, if the relationship between the context of the first device and the context regarding capturing of the media clip indicates that a media clip corresponding to the determined viewpoint does not exist in the collaborated content.

In some embodiments of the apparatus the means for obtaining the information on the context of the first device comprises means for receiving from the first device an indication of a selection of the viewpoint.

In some embodiments of the apparatus the means for obtaining the information on the context of the second device comprises means for receiving from the second device an indication of a selection of a viewpoint of the second device.

In some embodiments of the apparatus the media clips of the event comprises at least a video clip.

According to a fifth example there is provided a method comprising:
transmitting a request for content relating to a collaborated content to a device, the collaborated content comprising one or more media clips of an event attached with information on a context regarding capturing of the media clips;
transmitting information on the context of the device for determination of a viewpoint of the device in the collaborated content on the basis of a relationship between the context of the device and the context regarding capturing of the media clips; and
receiving an event composition generated from the one or more media clips of the collaborated content representing the determined viewpoint.

In some embodiments the method further comprises:
detecting changes of context of the device; and
transmitting information of changes of context of the device.

In some embodiments of the method the information on changes of context of the first device comprises information regarding at least one of the following:
a change of the location of the device;
a change of the inclination angle of the device; a gesture entered by a user of the device and detected by a user interface of the
device.

In some embodiments of the method transmitting the information on the context of the device comprises transmitting an indication of a selection of the viewpoint.

In some embodiments the method further comprises transmitting information on the instant of time for determining a starting point of the event composition.

In some embodiments of the method the media clips of the event comprises at least a video clip.

According to a sixth example there is provided an apparatus comprising at least one processor and at least one memory including computer program code, the at least one memory and the computer program code configured to, with the at least one processor, cause the apparatus to perform at least the following:
transmit a request for content relating to a collaborated content to a device, the collaborated content comprising one or more media clips of an event attached with information on a context regarding capturing of the media clips;
transmit information on the context of the device for determination of a viewpoint of the device in the collaborated content on the basis of a relationship between the context of the device and the context regarding capturing of the media clips; and
receive an event composition generated from the one or more media clips of the collaborated content representing the determined viewpoint.

In some embodiments the apparatus further comprises computer program code configured to, with the processor, cause the apparatus to:
detect changes of context of the device; and
transmit information of changes of context of the device.

In some embodiments of the apparatus the information on changes of context of the first device comprises information regarding at least one of the following:
a change of the location of the device;
a change of the inclination angle of the device;
a gesture entered by a user of the device and detected by a user interface of the device.

In some embodiments of the apparatus the transmitting the information on the context of the device comprises computer program code configured to, with the processor, cause the apparatus to transmit an indication of a selection of the viewpoint.

In some embodiments the apparatus further comprises computer program code configured to, with the processor, cause the apparatus to transmit information on the instant of time for determining a starting point of the event composition.

In some embodiments of the apparatus the media clips of the event comprises at least a video clip.

In some embodiments the apparatus comprises a communication device comprising:
a user interface circuitry and user interface software configured to facilitate a user to control at least one function of the communication device through use of a display and further configured to respond to user inputs; and
a display circuitry configured to display at least a portion of a user interface of the communication device, the display and display circuitry configured to facilitate the user to control at least one function of the communication device.

In some embodiments the communication device comprises a mobile phone.

According to a seventh example there is provided a computer program comprising at least one processor and at least one memory including computer program code, the at least one memory and the computer program code configured to, with the at least one processor, cause the apparatus to perform at least the following:
transmit a request for content relating to a collaborated content to a device, the collaborated content comprising one or more media clips of an event attached with information on a context regarding capturing of the media clips;
transmit information on the context of the device for determination of a viewpoint of the device in the collaborated content on the basis of a relationship between the context of the device and the context regarding capturing of the media clips; and
receive an event composition generated from the one or more media clips of the collaborated content representing the determined viewpoint.

In some embodiments the computer program further comprises one or more sequences of one or more instructions which, when executed by one or more processors, cause the apparatus to:
detect changes of context of the device; and
transmit information of changes of context of the device.

In some embodiments of the computer program the information on changes of context of the first device comprises information regarding at least one of the following:
a change of the location of the device;
a change of the inclination angle of the device;
a gesture entered by a user of the device and detected by a user interface of the device.

In some embodiments of the computer program the transmitting the information on the context of the device comprises one or more sequences of one or more instructions which, when executed by one or more processors, cause the apparatus to transmit an indication of a selection of the viewpoint.

In some embodiments the computer program further comprises one or more sequences of one or more instructions which, when executed by one or more processors, cause the apparatus to transmit information on the instant of time for determining a starting point of the event composition.

In some embodiments of the computer program the media clips of the event comprises at least a video clip.

In some embodiments the computer program is comprised in a computer readable memory.

In some embodiments of the computer program the computer readable memory comprises a non-transient computer readable storage medium.

According to an eighth example there is provided an apparatus comprising:
means for transmitting a request for content relating to a collaborated content to a device, the collaborated content comprising one or more media clips of an event attached with information on a context regarding capturing of the media clips;
means for transmitting information on the context of the device for determination of a viewpoint of the device in the collaborated content on the basis of a relationship between the context of the device and the context regarding capturing of the media clips; and
means for receiving an event composition generated from the one or more media clips of the collaborated content representing the determined viewpoint.

In some embodiments the apparatus further comprises:
means for detecting changes of context of the device; and
means for transmitting information of changes of context of the device.

In some embodiments of the apparatus the information on changes of context of the first device comprises information regarding at least one of the following:
a change of the location of the device;
a change of the inclination angle of the device;
a gesture entered by a user of the device and detected by a user interface of the device.

In some embodiments of the apparatus the means for transmitting the information on the context of the device comprises means for transmitting an indication of a selection of the viewpoint.

In some embodiments the apparatus further comprises means for transmitting information on the instant of time for determining a starting point of the event composition.

In some embodiments of the apparatus the media clips of the event comprises at least a video clip.

1-84. (canceled)

85. A method comprising:
receiving a request for transmitting content relating to a collaborated content to a first device, the collaborated content comprising one or more media clips of an event attached with information on a context regarding capturing of the media clips;
obtaining information on the context of the first device;
determining a viewpoint of the first device in the collaborated content on the basis of a relationship between the context of the first device and the context regarding capturing of the media clips; and
generating an event composition from the one or more media clips of the collaborated content representing the determined viewpoint.

86. A method of claim 85, wherein the information on context regarding capturing of the media clips comprises information of a constellation of one or more devices which captured the media clips.

87. A method of claim 86 further comprising obtaining information on the context of a second device.

88. A method of claim 87 further comprising forming a positional network between the first device and the second device.

89. A method of claim 87 further comprising:
using the information on the context of the first device and the information on the context of the second device to determine the constellation of the first device and the second device; and
comparing the determined constellation with the information of the constellation of one or more devices which captured the media clips to determine which devices in the constellation of one or more devices which captured the media clips correspond with the constellation of the first device and the second device.

90. A method of claim 89 further comprising:
using the information of a constellation of one or more devices which captured the media clips to determine a first distance representative of a distance between at least two devices which captured the media clips;
using the constellation of the first device and the second device to determine a second distance representative of a distance between the first device and the second device; and
determining a scaling factor on the basis of the first distance and the second distance.

91. A method of claim 85 further comprising:
receiving information of changes of context of the first device; and
reflecting the changes in the first device in the generation of the event composition.

92. A method of claim 91, wherein the information on changes of context of the first device comprises information regarding at least one of the following:
a change of the location of the first device;
a change of the inclination angle of the first device;
a gesture entered by a user of the first device and detected by a user interface of the first device.

93. A method of claim 85 further comprising:
synthesizing the event composition on the basis of two or more media clips of the collaborated content, if the relationship between the context of the first device and the context regarding capturing of the media clip indicates that a media clip corresponding to the determined viewpoint does not exist in the collaborated content.

94. A method of claim 85 further comprising selecting a media clip captured at a viewpoint nearest the viewpoint of the first device to the event composition, if the relationship between the context of the first device and the context regarding capturing of the media clip indicates that a media clip corresponding to the determined viewpoint does not exist in the collaborated content.

95. A method of claim 85, obtaining the information on the context of the first device comprising receiving from the first device an indication of a selection of the viewpoint.

96. A method of claim 87, obtaining the information on the context of the second device comprising receiving from the second device an indication of a selection of a viewpoint of the second device.

97. A method of claim 85, wherein the media clips of the event comprises at least a video clip.

98. An apparatus comprising at least one processor and at least one memory including computer program code, the at least one memory and the computer program code configured to, with the at least one processor, cause the apparatus to perform at least the following:
receive a request for transmitting content relating to a collaborated content to a first device, the collaborated content comprising one or more media clips of an event attached with information on a context regarding capturing of the media clips;
obtain information on the context of the first device;
determine a viewpoint of the first device in the collaborated content on the basis of a relationship between the context of the first device and the context regarding capturing of the media clips; and
generate an event composition from the one or more media clips of the collaborated content representing the determined viewpoint.

99. An apparatus of claim 98, wherein the information on context regarding capturing of the media clips comprising information of a constellation of one or more devices which captured the media clips.

100. An apparatus of claim 98 further comprising computer program code configured to, with the processor, cause the apparatus to:
receive information of changes of context of the first device; and
reflect the changes in the first device in the generation of the event composition.

101. An apparatus of claim 98 further comprising computer program code configured to, with the processor, cause the apparatus to:
synthesize the event composition on the basis of two or more media clips of the collaborated content, if the relationship between the context of the first device and the context regarding capturing of the media clip indicates that a media clip corresponding to the determined viewpoint does not exist in the collaborated content.

102. An apparatus of claim 98 further comprising computer program code configured to, with the processor, cause the apparatus to select a media clip captured at a viewpoint nearest the viewpoint of the first device to the event composition, if the relationship between the context of the first device and the context regarding capturing of the media clip indicates that a media clip corresponding to the determined viewpoint does not exist in the collaborated content.

103. An apparatus of claim 98, obtaining the information on the context of the first device comprising computer program code configured to, with the processor, cause the apparatus to receive from the first device an indication of a selection of the viewpoint.

104. A method comprising:
transmitting a request for content relating to a collaborated content to a device, the collaborated content comprising one or more media clips of an event attached with information on a context regarding capturing of the media clips;
transmitting information on the context of the device for determination of a viewpoint of the device in the collaborated content on the basis of a relationship between the context of the device and the context regarding capturing of the media clips; and
receiving an event composition generated from the one or more media clips of the collaborated content representing the determined viewpoint.

105. An apparatus comprising at least one processor and at least one memory including computer program code, the at least one memory and the computer program code configured to, with the at least one processor, cause the apparatus to perform at least the following:
transmit a request for content relating to a collaborated content to a device, the collaborated content comprising one or more media clips of an event attached with information on a context regarding capturing of the media clips;
transmit information on the context of the device for determination of a viewpoint of the device in the collaborated content on the basis of a relationship between the context of the device and the context regarding capturing of the media clips; and
receive an event composition generated from the one or more media clips of the collaborated content representing the determined viewpoint.
